(19) United States
(12) Patent Application Publication
(10) Pub. No.: US 2003/0074590 A1
(43) Pub. Date: Apr. 17, 2003

(54) Computer system with improved entry into powersave and lock modes and method of use therefor

(76) Inventors: Steven L. Fogle, Corvallis, OR (US); William A. Fischer, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/975,902

(22) Filed: Oct. 12, 2001

(51) Int. Cl. G06F 1/26; G06F 1/32

(52) U.S. Cl. 713/320

(57) ABSTRACT

A method, logic and computer system for managing electrical power consumed by a computer system and controlling access to functionality the computer system. A powersave mode is started after a first predetermined activity timeout duration has elapsed during which no user activity is detected, the powersave mode reducing an amount of electrical power consumed by a component of the computer system. A lock mode is started after a second predetermined activity timeout duration has elapsed during which no user activity is detected, following entry into the lock mode, the lock mode restricting use of the computer system until a specified security input is input into the computer system. Before the second predetermined activity timeout duration has elapsed, a user action other than the specified security input reactivates the computer system for use from the powersave mode.

### TECHNICAL FIELD

The present invention generally relates to computer systems and, more particularly, to computer system power management and access control.

### BACKGROUND

Computers are typically powered by connecting the computer to a power source, such as connection to a battery or connection to an electrical outlet coupled to a power grid supplied with power by a utility company. The conservation of electrical power, no matter the source, is of significant importance. Reducing the amount of power consumed by a computer receiving power from a power grid reduces the consumption of natural resources and lowers energy costs involved with operating the computer. Reducing the amount of power consumed by a computer receiving power from a battery extends the operational life of the battery and, if the battery is rechargeable, reduces the duration and number of times the battery needs to be recharged with power supplied by a utility company.

Computer hardware designers and programmers of operating systems for computers have attempted to reduce the amount of power consumed by computer systems by allowing the computer to enter into a powersave mode. Multiple types of powersave modes can be provided on a computer and include, for example, a standby mode (also known in the art as a suspend mode), a hibernation mode and/or a sleep mode, or some combination thereof. Some computer equipment manufacturers sometimes use the terms standby, hibernation (or hibernate), suspend and sleep with some overlap and inconsistency. The following defines the terms “standby” and “hibernation” (or “hibernate”) for use herein.

In standby mode (also referred to herein as a suspend mode), the computer leaves data in a main memory (such as a random access memory, or RAM) but the computer turns off or reduces the operation of non-critical systems to conserve power. For example, the computer may turn off a monitor or display device, stop the spinning of a hard drive, slow or stop a central processing unit (CPU), etc. In standby mode, random access memory (RAM) contents and hardware state information remains volatile. The standby mode can be activated by user action (e.g., by pressing a dedicated button, by a series of keystrokes, by mouse movements/clicks, by closing a hinged lid, or combination of actions) or automatically by the computer at the expiration of predetermined time following the last user action (or “standby activity timeout”). When the user wishes to again use the computer, the computer is reactivated by user action (e.g., by pressing a dedicated button, by a series of keystrokes, by mouse movements/clicks, by opening a hinged lid, or combination of actions).

In hibernation mode, the computer first copies all hardware state information and memory contents from RAM to a non-volatile storage device (such as a hard disk) and then completely powers down the computer system. On restart, the foregoing process reverses such that the computer system is rebooted and then the memory contents and hardware states are restored. Hibernation can be automatically activated after a time-out period or manually activated after specified user action. Also, the hibernation mode can be activated by the computer system due to a critically low battery condition.

Many computer operating systems also protect computers from unauthorized use by a password protection scheme. For example, the computer can be configured so that after a specified time of user inactivity, the computer enters a standby mode as described above to conserve power. The password protection feature can also be activated so that upon resuming from the standby mode, the computer requests a valid password from the user to allow access to the computing functions offered by the computer.

A standby/password function can be bothersome to use when the user configures the system to enter the standby mode after an activity timeout to conserve power and to request a password to protect against unauthorized use. More specifically, when the activity timeout is set to a short duration (e.g., about 5 minutes) and the user desires to reuse the system, the user must then enter his or her password. This means that after a brief distraction, such as taking a telephone call, the user may have to reenter his or her password to return to working on the computer. As a result, frequent use of the standby mode feature to conserve power is inhibited by the annoyance of the password protection feature.

Accordingly, there exists a need in the art for a user-friendly computer utility with improved standby mode and password protection mode (or lock mode) operation.

### BRIEF DESCRIPTION OF THE DRAWINGS

FIG. 1 is a block diagram of a computer system according to a preferred embodiment of the invention;

FIG. 2 is a time line illustrating operation of a standby/lock utility of the computer system of FIG. 1 according to a preferred embodiment of the invention;

FIG. 3A is a first exemplary flow chart of the standby/lock utility employed in the computer system of FIG. 1;

FIG. 3B is a second exemplary flow chart of the standby/lock utility employed in the computer system of FIG. 1; and

FIG. 4 is a graphical user interface generated by the standby/lock utility.

### DETAILED DESCRIPTION OF THE DRAWINGS

In the detailed description that follows, identical components have been given the same reference numerals, regardless of whether they are shown in different embodiments of the present invention.

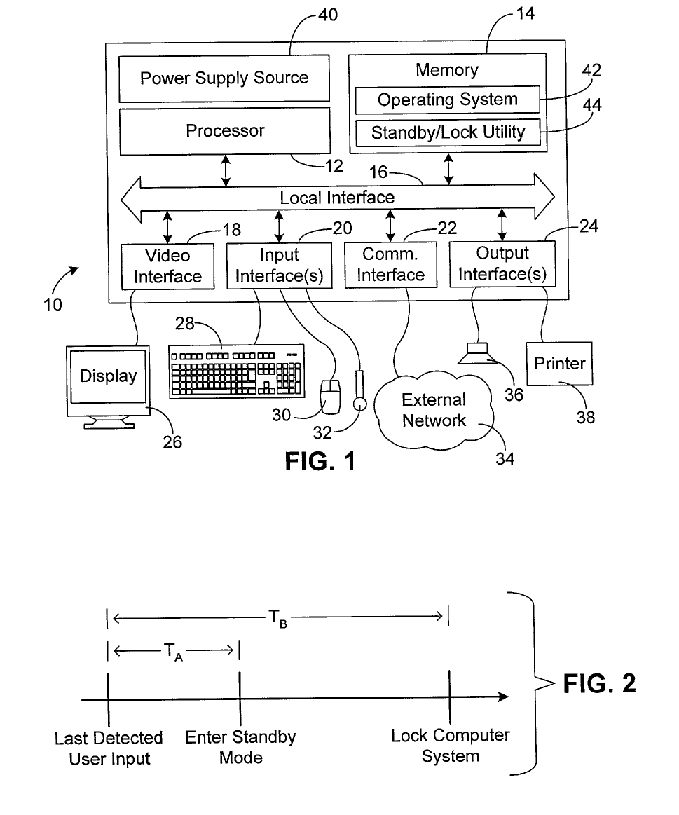

Referring initially to FIG. 1, a computer system 10 is illustrated. As used herein, the terms “computer system” and “computer” are used in a broad sense, and include devices such as network servers, desktop computers, workstations, portable computers (also referred to as laptop computers), personal digital assistants (PDAs), and the like. The computer system 10 has a processor 12 for executing instructions, usually in the form of a computer program, to carry out a specified logic routine. The illustrated processor 12 can represent multiple processors. The processor 12 can be electrical or optical in nature.

The computer system 10 also includes memory 14 for storing data, software, logic routine instructions, computer programs, files, operating system instructions, and the like. The memory 14 can comprise several devices and includes, for example, volatile and non-volatile memory components. Volatile memory components typically do not retain data values upon a loss of power. Non-volatile memory components retain data upon a loss of power. Thus, the memory 14 can include, for example, random access memory (RAM), read-only memory (ROM), hard disks, floppy disks, compact disks (including, but not limited to, CD-ROM, DVD-ROM and CD-RW), tapes, and/or other memory components, plus associated drives and players for these memory types. In addition, the RAM may comprise, for example, static random access memory (SRAM), dynamic random access memory (DRAM), magnetic random access memory (MRAM), and/or other such devices. The ROM may comprise, for example, programmable read only memory (PROM), erasable programmable read-only memory (EPROM), electrically erasable programmable read-only memory (EEPROM) and/or other like memory device.

The processor 12 and the memory 14 are coupled to a local interface 16. The local interface 16 can be, for example, a data bus with accompanying control bus, or a network between a processor and/or processors and/or memory or memories. Alternatively, the local interface 16 can be an appropriate network that facilitates communication between multiple processors, between a processor and a memory, or between multiple memories.

The computer system 10 has a video interface 18, a number of input interfaces 20, a communications interface 22, a number of output interfaces 24. Each interface 18, 20, 22 and 24 is coupled to the local interface 16.

The computer system 10 has a display 26 coupled to the local interface 16 via the video interface 18. Although shown as a cathode ray tube (CRT) type display, the display device may alternatively be, for example, a liquid crystal display (LCD), a plasma display, an electroluminescent display, indicator lights, or light emitting diodes (LEDs).

The computer system 10 can include input devices such as a keyboard 28, a mouse 30, and a microphone 32. Also, the computer system 10 can include, for example, a keypad (not shown), a touchpad (not shown), a touch screen (not shown), a joystick (not shown), a digital camera (not shown), a scanner (not shown), a digital pen (not shown), a data card reader (e.g., a smartcard reader) (not shown) and a biometric sensor (not shown). Each input device is coupled to the local interface 16 via the input interfaces 20.

The communications interface 22 can be, for example, a modem, network card and/or other type of transceiver. The communications interface 22 is coupled to an external network 34 enabling the computer system 10 to send and receive data signals, voice signals, video signals, and the like via the external network. The external network 34 can be, for example, the Internet, a wide area network (WAN), a local area network (LAN), direct data link, telephone network or other similar network or communications link, including wireless networks. Preferably, computer system 10 can be accessed and used by a remote user via the external network 34 and communications interface 22. Additionally, multiple communications interfaces 22 can be provided. The communications interface 22 can be configured for coupling to various types of media, such as a satellite transceiver, a coaxial cable, a fiber optic cable, telephone cable, network cable, wireless transmission or the like.

The computer system 10 can include output devices coupled to the computer system 10 via the output interfaces 24 or the external network 34. Output devices include, for example, audio speakers 36, a printer 38 and the like.

Many of the computer system 10 components receive electrical power from a power source 40. Computer system 10 components receiving power from the power source 40 can include the processor 12, the memory 14, the local interface 16, the video interface 18, the input interfaces 20, the communications interface 22, the output interfaces 24, the keyboard 28, the mouse 30, the microphone 32, and the speakers 36. On many portable computer systems 10, the display 26 also receives power from the power source 40. The power source 40 can be a battery such as, for example, a one-time use battery and/or a rechargeable battery. The power source 40 can also be a power supply coupled to, for example, an electrical outlet supplied with power by a utility company, a vehicle power system such as that found in an automobile, etc.

When the computer system 10 is not in use, it may be desirable to slow or turn off some of the computer system 10 components to reduce the amount of power drawn from the power source 40. Accordingly, the computer is provided with a standby, hibernate, or other powersave mode. Thus, the standby mode is one of many powersave or power management modes to which the present invention has application, including, for example, hibernate mode, suspend mode and/or sleep mode.

In the standby mode, the computer system 10 leaves data in a volatile memory component(s) of the memory 14, such as a RAM component. Also in the standby mode, the computer system turns off or reduces operation of other elements of the computer 10 to conserve power. For example, the computer system 10 may turn off the display 26, stop the operation of non-volatile memory devices, slow or stop operation of the processor 12, and the like.

The standby mode can be activated by user action such as depressing a dedicated button, making a series of keystrokes, by making a series of mouse movements and/or mouse button clicks, by closing a hinged lid of the computer system 10 that activates a switch or by a combination of actions. Alternatively, the standby mode can be activated automatically following a standby activity timeout having a predetermined duration, or T_{A}, during which there is no user action or input, such as pressing a key on the keyboard 28, moving or clicking the mouse 30 or speaking into the microphone 32. The standby mode can also be activated due to a low battery charge condition.

The standby mode can be deactivated to return the computer system 10 to normal operation by user action such as depressing a dedicated button, a series of keystrokes, depressing a key on the keyboard 28, by moving the mouse 30, by clicking a button on the mouse 30, by speaking into the microphone 32, by opening the hinged lid or any other single of combined group of actions.

The memory 14 stores an operating system 42 that is executed by the processor 12 to control the allocation and usage of resources in the computer system 10. Specifically, the operating system 42 controls the allocation and usage of the memory 14, the processing time of the processor 12 dedicated to various applications being executed by the processor 12, and the peripheral devices, as well as performing other functionality. In this manner, the operating system 42 serves as the foundation on which applications depend.

Many operating systems use a message-based operating environment. A message is a unit of information passed among running programs, certain devices in the computer system 12, and the operating system 42 itself. The messages include, for example, data relating to keyboard 28, mouse 30, and microphone 32 actions that are initiated by a user. Many other types of messages are exchanged within the computer system 10 running a message-based operating system 42.

The memory 14 also stores a power management and access control utility, also referred to herein as a standby/lock utility 44 (“standby” referring to an example power management mode and “lock” referring to an example access control technique), according to the present invention. The standby/lock utility 44 is executed by the processor 12 in conjunction with the operating system 42 to control entry into and exit from the standby mode described above or other powersave mode. In addition, the standby/lock utility 44 controls entry into and exit from a lock mode that allows the computer to restrict access to computer system resources and/or data until entry of a specified security input such as, for example, a valid password or satisfaction of some other security validation scheme (such as biometric scan of an individual's voice, retina, fingerprint, or the like). The lock mode desirably minimizes the unauthorized use of the computer system 10.

The lock mode can be activated in one of two ways. First, the lock mode can be activated by user action such as depressing a dedicated button, making a series of keystrokes, by making a series of mouse movements and/or mouse button clicks, by closing a hinged lid of the computer system 10 or by a combination of actions.

Second, the lock mode can be activated automatically following a lock activity timeout having a predetermined duration, or T_{B}, during which there is no user action or input such as pressing a key on the keyboard 28, moving the mouse 30, by clicking a button on the mouse 30 or speaking into the microphone 32.

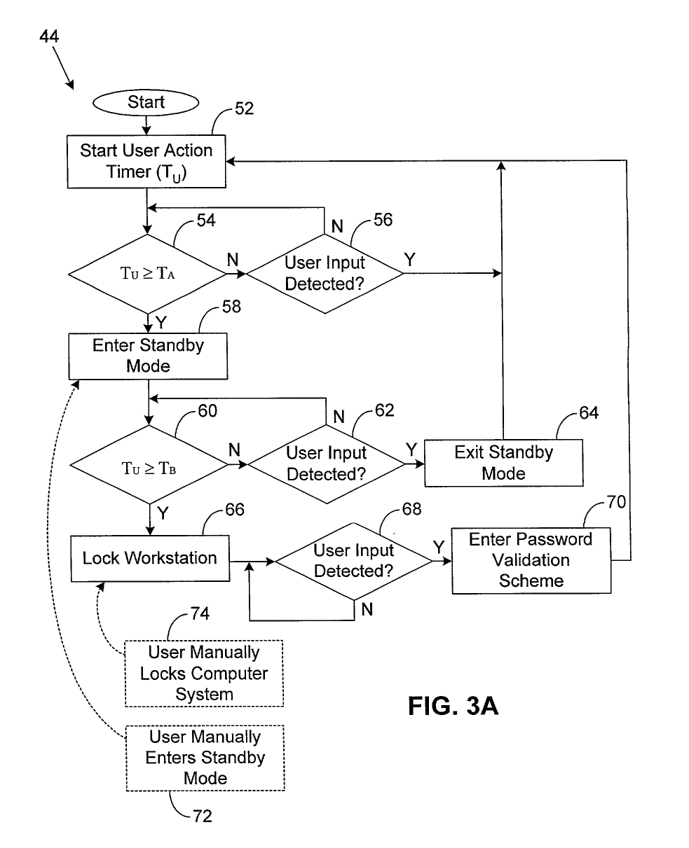

Referring now to FIG. 2, a timeline depicting the operation of the standby/lock utility 44 is illustrated. The standby/lock utility 55 monitors the computer system 10 for user activity. User activity includes depressing keys on the keyboard 28, moving the mouse 30, clicking a button on the mouse 30, speaking into the microphone 32, or similar action. In one embodiment, user activity is monitored by observing the operating system 42 and, more specifically, operating system messages that are indicative of user activity. Should a nonmessage-based operating system be used by the computer system 10, the standby/lock utility 44 can be configured to monitor any other appropriate signals or data packets that would indicate user activity.

If the predetermined standby activity timeout duration T_{A} elapses since the last detected user activity, or user input, then the standby/stop utility 44 places the computer system 10 in the standby mode. If the predetermined lock activity timeout duration T_{B} elapses since the last detected user activity, or user input, the standby/lock utility 44 places the computer system 10 in the lock mode.

The duration T_{B} is selected to be the same or longer than the duration T_{A}. In addition, the durations T_{A} and T_{B} are user defined. For example, the user may set T_{A} to be five minutes and T_{B} to be twenty minutes. Alternatively, T_{A} and T_{B} can be set to a default value.

After the standby activity timeout duration T_{A} has elapsed without user activity, but before expiration of the lock activity timeout duration T_{B}, the user can reactivate the computer system 10 (i.e., exit the standby mode) without completing the security validation scheme. However, after the lock activity timeout duration T_{B} has elapsed without user activity, the user preferably completes the security validation scheme to regain access to operation of the computer system 10. It is noted that the lock feature of the standby/lock utility 44 can be de-activated so that the computer system 10 enters the standby mode as described herein, but the computer system 10 does not enter the lock mode thereafter.

In another embodiment, the standby/lock utility 44 is configured to place the computer system 10 in the standby mode and then, following an additional period of time without user activity, the standby/lock utility 44 can place the computer system 10 into a hibernate mode or other powersave mode, as well as possibly in the lock mode.

Also, the standby/lock utility 44 can be used to place the computer system 10 in hibernate mode to, for example, allow the user to swap batteries or otherwise switch power sources. Once the power source has been changed and the computer system 10 is brought out of the hibernation mode, the security validation scheme would not need to be satisfied.

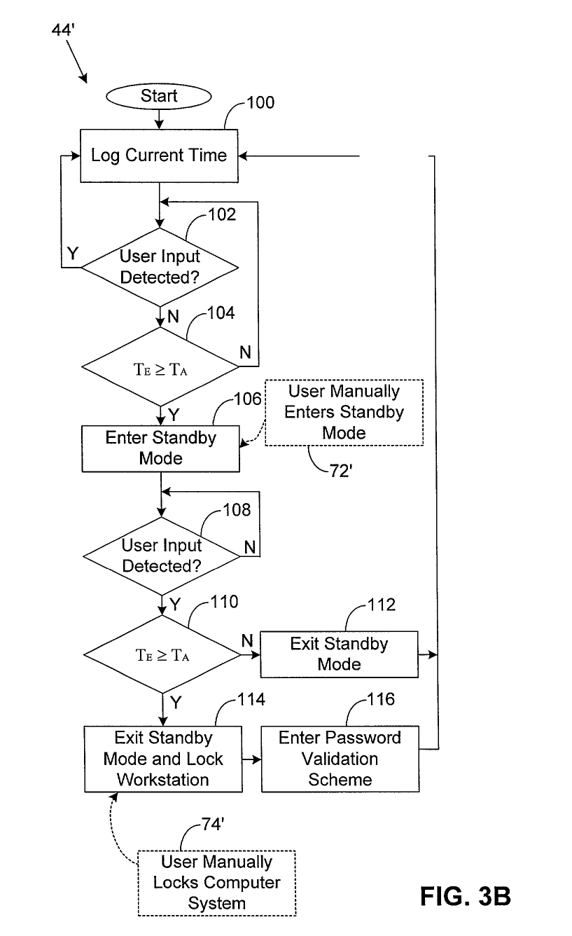

With reference to FIG. 3A, shown is a first exemplary flow chart of the standby/lock utility 44 according to an embodiment of the present invention. Alternatively, the flow chart of FIG. 3A can be thought of as depicting steps in a method implemented in the computer system 10 (FIG. 1).

The standby/lock utility 44 starts in box 52 where a user action timer, or T_{U}, is started and run, or incremented, to track the time since the last detected user activity, or input. The term timer, as used herein, can also include logging the time at a certain instant and comparing the current time (or the time at another instant) against the logged time to derive an elapsed time.

Next, in box 54 the user action timer T_{U} is compared against the predetermined standby activity timeout duration T_{A}. If T_{U} is less than T_{A} then the standby/lock utility 44 proceeds to box 56 where the standby/lock utility 44 monitors for user activity. If a user input is detected in box 56 the standby/lock utility 44 returns to box 52 where the user action timer T_{U} is restarted. If no user input is detected in box 56, the standby/lock utility 44 returns to box 54.

If, in box 54, T_{U} is greater than or equal to T_{A}, the standby/lock utility 44 proceeds to box 58 where the computer system 10 is placed in the standby mode as described above. Next, in box 60, T_{U} is compared against the predetermined lock activity timeout duration T_{B}. If T_{U} is less than T_{B}, the standby/lock utility 44 proceeds to box 62 where user activity is monitored. If a user activity is detected in box 62, the standby/lock utility 44 proceeds to box 64 where the computer system 10 is reactivated, or brought out of standby mode. Subsequently, the standby/lock utility 44 returns to box 52 where the user action timer T_{U} is reset. If, in box 62, no user action is detected, the standby/lock utility 44 returns to box 60.

In box 60, if T_{U} is greater than or equal to T_{B}, the standby/lock utility 44 locks the workstation in box 66 to protect against unauthorized use of the computer system 10. Thereafter, in box 68 the standby/lock utility 44 monitors for user activity. Box 68 cycles on itself until user activity is detected. Alternatively, the computer system 10 is placed in a hibernation mode or other powersave mode following a predetermined time of user inactivity.

If user activity is detected in box 68, the standby/lock utility 44 proceeds to box 70 where the user is asked for a valid password or to satisfy some other security validation scheme before allowing access to the resources of the computer system 10. Entry into the security validation scheme in box 70 may involve at least partially exiting from the standby mode. If the user does not unlock the computer system 10 by satisfying the security validation scheme in box 70, the standby/lock utility 44 causes the computer system 10 to fully re-enter the standby mode after a specified period of time and return to box 68 to monitor for user activity.

The standby/lock utility 44 also allows the user to manually enter the standby mode as illustrated by functional block 72. If the user manually enters standby mode, the standby/lock utility 44 is placed in box 58 regardless of what box the standby/lock utility 44 is currently carrying out. Since manual entry into standby mode would constitute a user action, the user action timer T_{U} can be reset upon manual entry into standby mode or can be left unchanged for subsequent comparison against the predetermined lock activity timeout duration T_{B}.

The user can also lock the computer system manually as illustrated in processing block 74. Upon carrying out of the user action to manually lock the workstation, the standby/lock utility 44 is placed in box 66 regardless of what box the standby/lock utility 44 is currently carrying out. Also, upon manually locking the computer system 10 or following a predetermined duration thereafter, the standby/lock utility 44 can place the computer system 10 in standby mode or other powersave mode.

With reference to FIG. 3B, shown is a second exemplary flow chart of a standby/lock utility 44′ according to an embodiment of the present invention. Alternatively, the flow chart of FIG. 3B can depict steps in a method implemented in the computer system 10 (FIG. 1).

The standby/lock utility 44′ starts in box 100 where the current time is logged for subsequent recall and comparison against a later time to derive an elapsed time. Alternatively, a user action timer is started and run, or incremented, as described above for the standby/lock utility 44.

Next, in box 102, the standby/lock utility 44′ monitors for user activity. If a user input is detected in box 102, the standby/lock utility 44′ returns to box 100 where the current time is logged. If no user input is detected in box 102, the standby/lock utility 44′ proceeds to box 104 where the logged time is compared against the current time to derive an elapsed time, or T_{E}. The elapsed time T_{E} is compared against the predetermined standby activity timeout duration T_{A}. If T_{E} is less than T_{A} then the standby/lock utility 44′ return to box 102.

If, in box 104, T_{E} is greater than or equal to T_{A}, the standby/lock utility 44′ proceeds to box 106 where the computer system 10 is placed in the standby mode as described above.

Next, in box 108, user activity is monitored. The standby/lock utility 44′ monitors for user activity in box 108 until user activity is detected. Once user activity is detected in box 108, the standby/lock utility 44′ proceeds to box 110 where the logged time (box 100) is compared against the current time to derive an elapsed time, or T_{E}. The elapsed time T_{E} is compared against the predetermined lock timeout duration T_{B}. If T_{E} is less than T_{B} then the standby/lock utility 44′ proceeds to box 112 where the computer system 10 is brought out of the standby mode. Thereafter, the standby/lock utility 44′ returns to box 100. Other events may be used to trigger the standby/lock utility 44′ to bring the computer system 10 out of standby mode and proceed to another operational mode, such as, for example, a critically low battery charge condition where it may be desirable to place the computer system 10 in a hibernation mode from the standby mode.

If, in box 110, T_{E} is greater than or equal to T_{B}, the standby/lock utility 44′ proceeds to box 114 where the computer system 10 is brought out of standby mode and locked in such a manner that user access to the computer system 10 is not granted until a password validation scheme is satisfied (box 116).

The standby/lock utility 44′ also allows the user to manually enter the standby mode as illustrated by functional block 72′. If the user manually enters standby mode, the standby/lock utility 44′ is placed in box 106 regardless of what box the standby/lock utility 44′ is currently carrying out. Since manual entry into standby mode constitutes a user action, the logged time can be reset upon manual entry into standby mode or can be left unchanged for subsequent derivation of an elapsed time T_{E}.

The user can also lock the computer system manually as illustrated in processing block 74′. Upon carrying out of the user action to manually lock the workstation, the standby/lock utility 44′ is placed in box 114 regardless of what box the standby/lock utility 44′ is currently carrying out. Also, upon manually locking the computer system 10 or following a predetermined duration thereafter, the standby/lock utility 44′ can place the computer system 10 in standby mode or other powersave mode.

It is believed that the second example standby/lock utility 44′ implementation consumes less power while in standby mode than the first example standby/lock utility 44 since, in the second example standby/lock utility 44′ implementation, no timer is incremented and monitored to place the computer system in a lock mode after a specified time. Further, the act of placing the computer system 10 in the lock mode (as in the first example) also consumes some amount of power.

One skilled in the art will appreciate that the flow chart of FIGS. 3A and 3B can be modified. For example, in the standby/lock utility 44′, exiting the standby mode (box 112) can be conducted before comparison of the elapsed time with the predetermined lock timeout duration T_{B} (box 110). Thereafter, the computer system 10 can be made available to the user or locked as is appropriate.

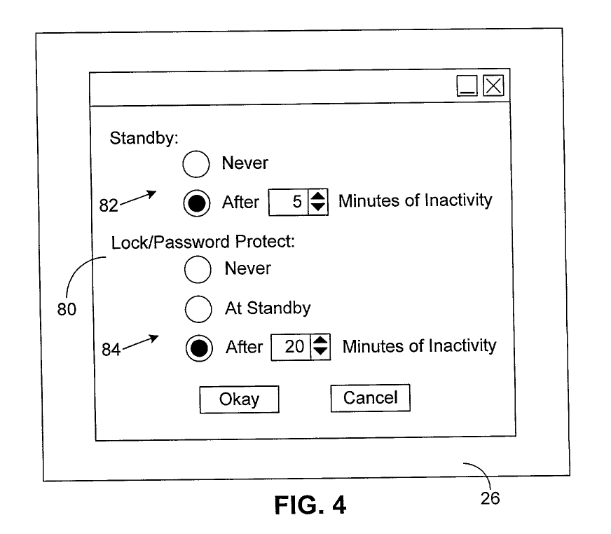

With additional reference to FIG. 4, the standby/lock utility 44 or 44′ can generate a graphical user interface (GUI) 80 for display on the display 26 to assist the user in configuring the standby/lock utility 44 or 44′. As one skilled in the art will appreciate, the illustrated GUI 80 is exemplary and other GUIs can be used, including GUIs offering a subset, alternative or additional menu option than those illustrated.

The GUI 80 can include two content-sensitive menus. A first content-sensitive menu 82 allows the user to specify when the standby/lock utility 44 or 44′ automatically places the computer system 10 in the standby mode. For example, the first content-sensitive menu can include a “never” option, which, if selected, disables automatic entry into the standby mode. The first content-sensitive menu can also include a choice for the user to specify the standby activity timeout duration T_{A}.

The GUI 80 can include a second content-sensitive menu allowing the user to specify when the standby/lock utility 44 or 44′ locks, or password protects, the computer system 10. In a manner that accords with the first content-sensitive menu 82, the second content-sensitive menu 84 can include a “never” option and a selection for the user to define the lock activity timeout duration T_{B}. The second content-sensitive menu 84 can also include an option for the user to select entry into the lock mode whenever the computer system 10 enters standby mode.

Although the logic used to carry out the standby/lock utility 44 or 44′ of the examples of FIGS. 3A and 3B are embodied in software or code executed by general purpose processor hardware as discussed above, the standby/lock utility 44 or 44′ can alternatively be embodied in dedicated hardware or a combination of software/general purpose hardware and dedicated hardware. If embodied in dedicated hardware, the logic can be implemented as a circuit or state machine that employs any one of or a combination of a number of techniques. These technologies may include, but are not limited to, discrete logic circuits having logic gates for implementing various logic functions upon an application of one or more data signals, application-specific integrated circuits having appropriate logic states, programmable gate arrays (PGA), field programmable gate arrays (FPGA) or other components, etc. Such technologies are generally well known by those skilled in the art and, consequently, are not described in detail herein.

The figures show the architecture, functionality, and operation of an implementation of the standby/logic utility 44 or 44′. If embodied in software, each illustrated block may represent a module, segment, or portion of code that comprises program instructions to implement the specified logical function(s). The program instructions may be embodied in the form of source code that comprises human readable statements written in a programming language or machine code that comprises numerical instructions recognizable by a suitable execution system such as a processor in a computer system or other system. The machine code may be converted from the source code. If embodied in hardware, each block may represent a circuit or a number of interconnected circuits to implement the specified logical function(s).

Although the standby/lock utility 44 or 44′ illustrates a specific order of execution, it is understood that the order of execution may differ from that which is depicted. For example, the order of execution of two or more blocks may be changed relative to the order shown. Also, two or more blocks shown in succession may be executed concurrently or with partial concurrence. In addition, any number of counters, state variables, warning semaphores, or messages might be added to the logical flow described herein, for purposes of enhanced utility, accounting, performance measurement, or providing troubleshooting aids, and the like.

Also, where the standby/lock utility 44 or 44′ comprises software or code, the standby/lock utility 44 or 44′ can be embodied in any computer readable medium for use by or in connection with an instruction execution system such as, for example, a processor in a computer system or other system. In this sense, the logic may comprise, for example, statements including instructions or declarations that can be fetched from the computer-readable medium and executed by the instruction logic system. In the context of the present invention, a “computer-readable medium” can be any medium that can contain, store or maintain the logic described herein for use by or in connection with the instruction execution system. A computer-readable medium can comprise any one of many physical media such as, for example, electronic, magnetic, optical, electromagnetic, or semiconductor media. More specific examples of suitable computer-readable medium includes, but are not limited to, magnetic tapes, magnetic floppy diskettes, magnetic hard drives, or compact disks. Also, the computer-readable medium can be random access memory (RAM) including, for example, static random access memory (SRAM), and dynamic random access memory (DRAM), or magnetic random access memory (MRAM). In addition, the computer-readable medium can be a read-only memory (ROM), a programmable read-only memory (PROM), an erasable programmable read-only memory (EPROM), an electronically erasable programmable read-only memory (EEPROM), or other type of memory device.

Although particular embodiments of the invention have been described in detail, it is understood that the invention is not limited correspondingly in scope, but includes all changes, modifications and equivalents coming within the spirit and terms of the claims appended hereto.

What is claimed is:

1. A method of controlling access to functionality of a computer system, comprising:
entering a powersave mode after a first predetermined activity timeout duration has elapsed during which no user activity is detected, the powersave mode reducing an amount of electrical power consumed by a component of the computer system; and
entering a lock mode after a second predetermined activity timeout duration has elapsed during which no user activity is detected, following entry into the lock mode, the lock mode restricting use of the computer system until a specified security input is input into the computer system;
wherein, following entry into the powersave mode but before the second predetermined activity timeout duration has elapsed, a user action other than the specified security input reactivates the computer system for use from the powersave mode.

2. The method according to claim 1, further comprising monitoring operating system messages for a message indicative of user activity.

3. The method according to claim 2, further comprising running a user action timer and resetting the user action timer upon detection of user activity.

4. The method according to claim 1, further comprising running a user action timer and resetting the user action timer upon detection of user activity.

5. The method according to claim 1, further comprising logging a current time for comparison against a subsequent time to derive an elapsed time during which no user activity is detected.

6. The method according to claim 1, wherein the first activity timeout duration and the lock activity timeout duration are user definable.

7. The method according to claim 1, wherein the powersave mode is a standby mode during which contents of a volatile memory of the computer system remain volatile.

8. The method according to claim 1, wherein second activity timeout duration is greater than the first activity timeout duration.

9. A program embodied in computer readable medium to manage electrical power consumed by a computer system and control access to functionality the computer system, comprising:
code that places the computer system in a powersave mode after a first predetermined activity timeout duration has elapsed during which no user activity is detected, the powersave mode reducing an amount of electrical power consumed by a component of the computer system; and
code that places the computer system in a lock mode after a second predetermined activity timeout duration has elapsed during which no user activity is detected, following entry into the lock mode, the lock mode restricting use of the computer system until a specified security input is input into the computer system;
wherein, the second activity timeout duration is greater than the first activity timeout duration such that following entry into the powersave mode but before the second predetermined activity timeout duration has elapsed, a user action other than the specified security input reactivates the computer system for use from the powersave mode.

10. The program embodied in computer readable medium according to claim 9, further comprising code that monitors operating system messages for a message indicative of user activity.

11. The program embodied in computer readable medium according to claim 9, further comprising code that runs a user action timer and code that resets the user action timer upon detection of user activity.

12. The program embodied in computer readable medium according to claim 9, further comprising code that runs a user action timer and code that resets the user action timer upon detection of user activity.

13. The program embodied in computer readable medium according to claim 9, further comprising code that logs a current time for comparison against a subsequent time to derive an elapsed time during which no user activity is detected.

14. The program embodied in computer readable medium according to claim 9, wherein the standby activity timeout duration and the lock activity timeout duration are user definable.

15. The program embodied in computer readable medium according to claim 9, wherein the powersave mode is a standby mode during which contents of a volatile memory of the computer system remain volatile.

16. A computer system having a utility for managing electrical power consumed by a computer system and for controlling access to functionality the computer system, comprising:
means for placing the computer system in a powersave mode after a first predetermined activity timeout duration has elapsed during which no user activity is detected, the powersave mode reducing an amount of electrical power consumed by a component of the computer system; and
means for placing the computer system in a lock mode after a second predetermined activity timeout duration has elapsed during which no user activity is detected, following entry into the lock mode, the lock mode restricting use of the computer system until a specified security input is input into the computer system;
wherein, the second activity timeout duration is greater than the first activity timeout duration such that following entry into the powersave mode but before the second predetermined activity timeout duration has elapsed, a user action other than the specified security input reactivates the computer system for use from the powersave mode.

17. The computer system according to claim 16, further comprising means for monitoring operating system messages for a message indicative of user activity.

18. The computer system according to claim 17, further comprising means for running a user action timer and means for resetting the user action timer upon detection of user activity.

19. The computer system according to claim 16, further comprising means for running a user action timer and means for resetting the user action timer upon detection of user activity.

20. The computer system according to claim 16, further comprising means for logging a current time for comparison against a subsequent time to derive an elapsed time during which no user activity is detected.

21. The computer system according to claim 16, wherein the standby activity timeout duration and the lock activity timeout duration are user definable.

22. The computer system according to claim 16, wherein the powersave mode is a standby mode during which contents of a volatile memory of the computer system remain volatile.
